(19) United States
(12) Patent Application Publication
(10) Pub. No.: US 2016/0164392 A1
(43) Pub. Date: Jun. 9, 2016

(54) LINEAR MOTOR

(71) Applicant: HON HAI PRECISION INDUSTRY CO., LTD., New Taipei (TW)

(72) Inventors: MI-CHIEN CHEN, New Taipei (TW); CHI-HUAN SHAO, New Taipei (TW)

(21) Appl. No.: 14/688,777

(22) Filed: Apr. 16, 2015

(30) Foreign Application Priority Data
Dec. 8, 2014 (TW) 103142570

(51) Int. Cl. H02K 41/02; H02K 9/02

(52) U.S. Cl. CPC H02K 41/02; H02K 9/02

(57) ABSTRACT

A linear motor includes a base, a stator positioned on the base, a mover positioned in the stator and configured to move relative to the stator, and two air guiding devices. The stator has two opposite openings. Each air guiding device is positioned adjacent to one respective opening to speed up an air circulation in the stator for cooling.

### FIELD

The subject matter herein generally relates to a driving mechanism, and particularly to a linear motor.

### BACKGROUND

One of the most common and important problems in the application of motors is the temperature rise resulting from various losses, such as copper losses, brush-contact loss, core loss, mechanical loss, stray load loss, etc. And, as well known in the art, the operating temperature of a motor is closely associated with its life expectancy, because deterioration of the insulation is a function of both time and temperature. Therefore, various cooling means or ventilating systems are proposed for such machines to remove the heat arising from the inevitable losses, and thus to prevent overheating of the machines.

### BRIEF DESCRIPTION OF THE DRAWINGS

Implementations of the present technology will now be described, by way of example only, with reference to the attached figures.

FIG. 1 illustrates an assembled, isometric view of a linear motor including a base.

FIG. 2 is an isometric view of the base of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

A linear motor can include a base, a stator positioned on the base, a mover positioned in the stator and configured to move relative to the stator, and two air guiding devices. The stator can have two opposite openings at opposite ends. Each air guiding device can be positioned adjacent to a respective one opening to speed up air circulation in the stator to provide cooling.

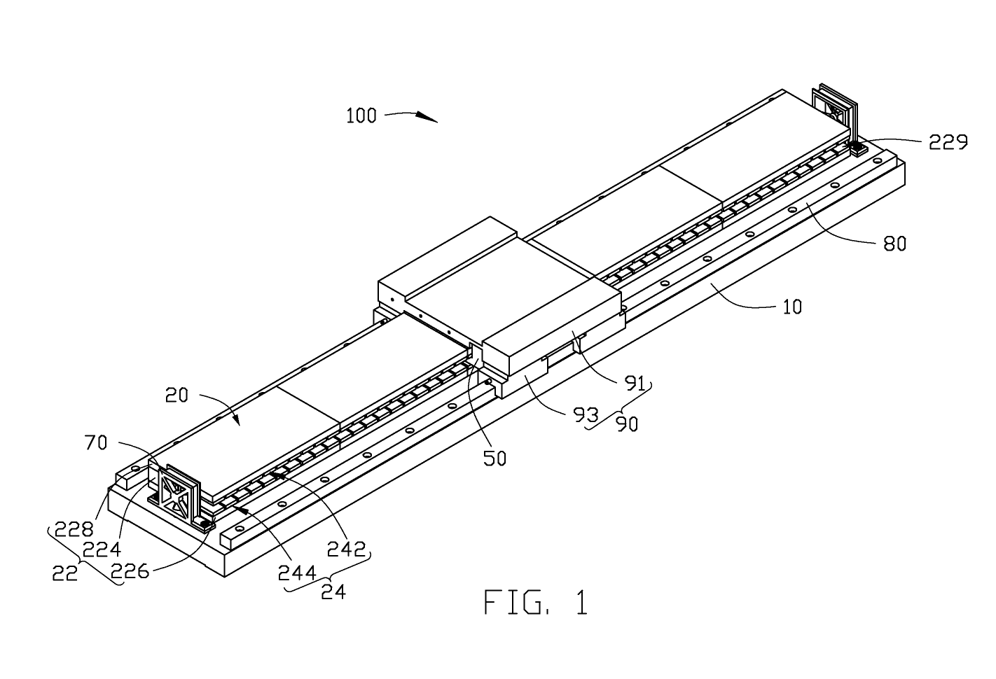

FIG. 1 illustrates a linear motor 100 including a base 10, a stator 20 positioned on the base 10, a mover 50 positioned in the stator 20 and configured to move relative to the stator 20, and two air guiding devices 70. The stator 20 can have two opposite openings 229. Each air guiding device 70 can be positioned adjacent to one respective opening 229 to speed up an air circulation in the stator 20 for cooling.

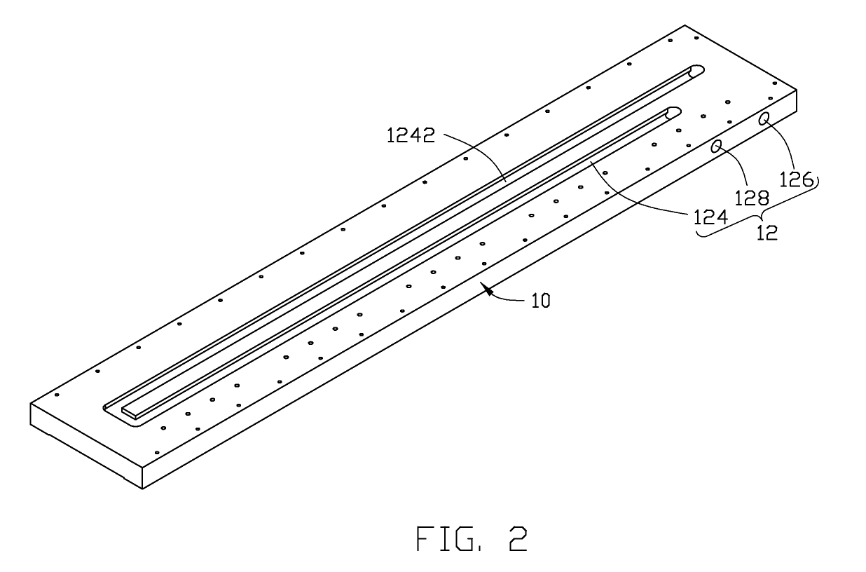

Also referring to FIG. 2, the base 10 can be a substantially rectangular board. The base 10 can define a cooling passage 12. The cooling passage 12 can be air communicating with an outer environment for flowing fluid. The cooling passage 12 can include a communicating portion 124, an inlet 126, and an outlet 128. The communicating portion 124 can be formed in the base 10. The communicating portion 124 can be substantially in a U shape and can have an opening 1242. The inlet 126 and the outlet 128 can be air communicating with the communicating portion 124 and separately defined in a sidewall of the base 10. The inlet 126 can be coupled to an outer device for providing fluid and gas, for guiding air or fluid into the communicating portion 124. The outlet 128 can be used for ejecting the fluid or air out of the base 10 to cool the base 10.

The stator 20 can be positioned on the base 10. In the illustrated embodiment, the stator 20 can include a stator support 22 and a permanent magnet group 24 positioned in the stator support 22. The stator support 22 can be positioned on the base 10. The stator support 22 can be in a U shape and include a first sidewall 224, a second sidewall 226, and a third sidewall 228. The second sidewall 226 can be fixed to the base 10 and cover the opening 1242. The first sidewall 224 can be interconnected between the second sidewall 226 and the third sidewall 228. The permanent magnet group 24 can include a first permanent magnet group 242 and a second magnet group 244. The first permanent magnet group 242 can be positioned on a side surface of the third sidewall 228 toward the second sidewall 226, and the second magnet group 244 can be positioned on a side surface of the second sidewall 226 toward the third sidewall 228. The two opening 229 can be positioned oppositely at the stator support 22.

The mover 50 can be positioned between the first permanent magnet group 242 and the second magnet group 244. In the illustrated embodiment, the mover 50 can have a coil (not shown). Magnet fields produced by the first permanent magnet group 242 and the second magnet group 244 can interact with a magnet field generated by the mover 50 to move the mover 50 relative to the stator 20.

Each one air guiding device 70 can be positioned on the base 10 and positioned adjacent to the one respective opening 229. The stator support 22 can be positioned between the two air guiding devices 70. The stator support 22 and the two air guiding devices 70 can be arranged in line. In the illustrated embodiment, the air guiding devices 70 can be fans. Air circulation in the stator 20 can be speeded up when the air guiding devices 70 work, and heat generated during an operation of the linear motor 100 can be exchanged with an outer environment to cool work temperature of the linear motor 100. In other embodiments, the air guiding device 70 can be air blow guns. Gas can be injected by the air blow guns into the stator support 22 and enable air circulation in the stator 20 for heat exchange with the outer environment. The air guiding devices 70 can be other embodiments, and it just can speed up the air circulation in the stator 20.

The linear motor 100 can further include two sliding rails 80 and the mounting base 90. The two sliding rails 80 can be positioned on the base 10 and spaced from the stator support 22. The stator support 22 can be positioned between the two sliding rails 80. The mounting base 90 can include a main body 91 and a plurality of sliding blocks 93 mounted on opposite edges of the main body 91. The main body 91 can be fixedly coupled to the main body 91, and the sliding blocks 93 can be slidably coupled to respective sliding rail 80.

In use, water or other cooling medium can be injected into the communicating portion 124 via the inlet 126 and ejected out of the base 10 via the outlet 128. The air guiding devices 70 can be operated to work. Heat generated during the operation of the linear motor 100 can be transmitted to the stator 20. The work temperature of the linear motor 100 can be cooled down by operations of a fluid cooling system of the base 10 and the air guiding device 70.

In other embodiments, the cooling passage 12 can be omitted. The number of the cooling passage 12 can be one more. The one more cooling passages 12 can be separately formed in the base 10. A shape of the cooling passage 12 can be designed to be in other shapes, such as in a linear shape or a Z shape. The cooling passage 12 can have a plurality of turnings. The opening 1242 of the cooling passage 12 can be omitted, and it can have a top sidewall. The inlet 126 and the outlet 128 can be not limited to be at a same sidewall of the base 10, they can be positioned at different sidewalls of the base 10.

In other embodiments, the number of the air guiding device 70 can be one, and it just can be positioned adjacent to one opening 229. The number of the air guiding device 70 can be more than two, and it can be positioned adjacent to the openings 229 according to real application.

In other embodiment, the sliding rail 80 and the mounting base 90 can be omitted. The number of the sliding rail 80 can be one, and the sliding block 93 can be just one to slidably engaging with the sliding rail 80.

The embodiments shown and described above are only examples. Many details are often found in the art such as the other features of a linear motor. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A linear motor, comprising:
a base;
a stator positioned on the base and having two openings at opposite ends;
a mover positioned in the stator and configured to move relative to the stator; and
at least one air guiding device positioned adjacent to a respective one of the two openings and configured to speed up air circulation in the stator to provide cooling.

2. The linear motor of claim 1, wherein the stator comprises a stator support, a first permanent magnet group, and a second magnet group, the stator support is positioned on the base, the first permanent magnet group and a second magnet group positioned opposite sidewalls of the stator support, the mover is positioned between the first permanent magnet group and the second magnet group, the two opening are positioned oppositely at the stator support.

3. The linear motor of claim 2, wherein the stator support is in a U shape, the stator support comprises a first sidewall, a second sidewall, and a third sidewall, the second sidewall is fixed to the base, the first sidewall is interconnected between the second sidewall and the third sidewall, the first permanent magnet group is positioned on a side surface of the third sidewall toward the second sidewall, and the second magnet group is positioned on a side surface of the second sidewall toward the third sidewall.

4. The linear motor of claim 2, wherein the number of the at least one air guiding device is two, each one air guiding device is positioned adjacent to one respective opening, and the stator support is positioned between the two air guiding devices.

5. The linear motor of claim 4, wherein the stator support and the two air guiding devices are arranged in line.

6. The linear motor of claim 1, wherein the at least one air guiding device is a fan.

7. The linear motor of claim 1, wherein the base defines a cooling passage, the cooling passage is air communicating with outer environment for flowing fluid.

8. The linear motor of claim 7, wherein the cooling passage comprises a communicating portion, an inlet, and an outlet, the communicating portion is formed in the base, the inlet and the outlet are communicating with the communicating portion and separately defined in a sidewall of the base.

9. The linear motor of claim 1, wherein the linear motor further comprises a sliding rail and the mounting base, the sliding rail is positioned on the base and spaced from the stator, and the mounting base is slidably coupled to the sliding rail and fixedly coupled to the mover.

10. The linear motor of claim 9, wherein the mounting base comprises a main body and a sliding block mounted on the main body, the main body is fixedly coupled to the mover and the sliding block is slidably coupled to the sliding rail.
